(19) United States
(12) Patent Application Publication
(10) Pub. No.: US 2025/0350969 A1
(43) Pub. Date: Nov. 13, 2025

(54) TIMING ACCURACY OF RADIO DATA PACKETS

(71) Applicant: Siemens Industry Software Inc., Plano, TX (US)

(72) Inventor: Miika Niiranen, Pirkkala (FI)

(21) Appl. No.: 18/870,930

(22) PCT Filed: Jun. 29, 2022
(86) PCT No.: PCT/IB2022/056043

§ 371 Date: Dec. 2, 2024

(51) Int. Cl. H04W 24/06; H04B 17/00

(52) U.S. Cl. CPC H04W 24/06; H04B 17/0085

(57) ABSTRACT

A method for determining timing accuracy of one or more radio data packets includes: generating stimulus data, wherein the stimulus data includes the radio data packets and a reference time for transmission of the radio data packets over the air; storing the stimulus data on a test device; and replaying the stimulus data, by the test device, in order to determine the timing accuracy of the transmission of the one or more radio data packets by a device under test.

This application is a § 371 nationalization of PCT Application Serial No. PCT/IB2022/056043, filed Jun. 29, 2022, designating the United States, which is hereby incorporated by reference in its entirety.

### TECHNICAL FIELD

The present disclosure relates to the timing of one or more radio data packets. In particular, the disclosure relates to transmission and/or reception of the radio data packets over a fronthaul network. More particularly, the disclosure relates to testing of radio equipment.

### BACKGROUND

In a fronthaul of a radio network, the antenna data needs to be carried over longer distances. Therefore, strict throughput latency, jitter, timing, and synchronization requirements need to be respected. Hence, the transmission over the fronthaul requires a strict synchronization and timing mechanism, like Precision time Protocol (PTP), e.g., between the radio unit, RU, and the baseband unit, BBU, to provide appropriate transmission and/or reception of data packets.

To provide compliant synchronization, the proper functioning of radio equipment of a radio network needs to be verified. To that end, testing of the radio equipment needs to be performed. For example, a test device may also act as a PTP master and provide that fronthaul messages are replayed honoring specified timestamps enabling testing of required timing windows.

### SUMMARY

It is therefore an object to improve examination and verification of transmission and/or reception of radio data packets over the fronthaul with respect to timing.

The scope of the present disclosure is defined solely by the appended claims and is not affected to any degree by the statements within this summary. The present embodiments may obviate one or more of the drawbacks or limitations in the related art.

### BRIEF DESCRIPTION OF THE DRAWINGS

FIG. 1 depicts an example of a test system including a test device coupled to a baseband unit and a radio unit.

FIG. 2 depicts an example of a test system including a test device coupled to a radio unit.

FIG. 3 depicts an example of timing requirements between a baseband unit and a radio unit.

FIG. 4 depicts an example of radio data packets.

FIG. 5 depicts an example of stimulus including the radio data packets and a reference time.

FIG. 6 depicts an example a test device for replaying and recording of fronthaul radio data packets.

FIG. 7 depicts an example of a transmission of radio data packets and a reference pulse.

FIG. 8 depicts an example of a visualization of radio data packet transmission over the fronthaul and acceptable time windows for RF symbol transmission.

FIGS. 9 to 15 depict exemplary acts according to a plurality of embodiments.

### DETAILED DESCRIPTION

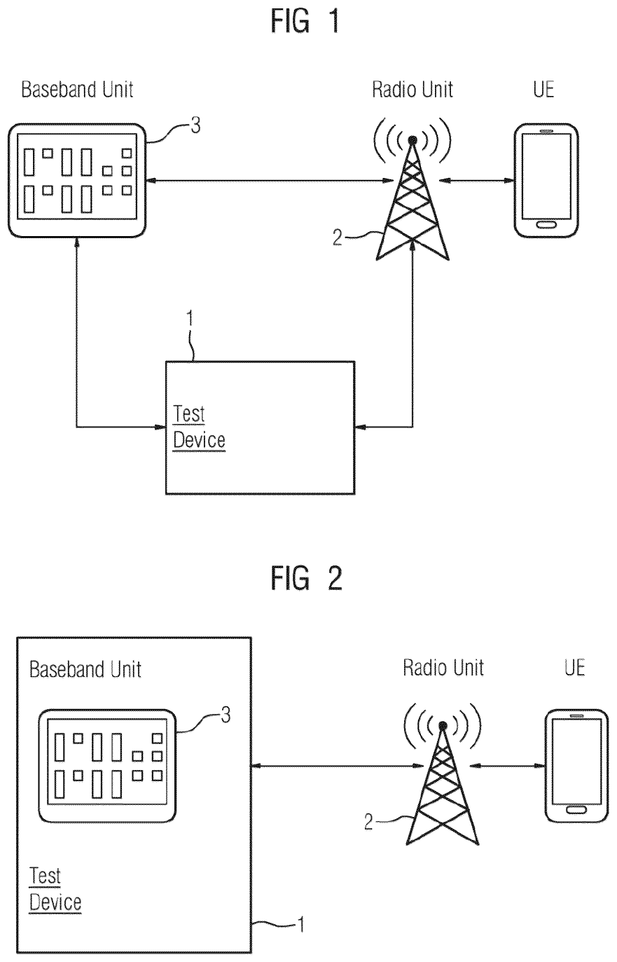

In the test system of FIG. 1, a baseband unit, BBU, performs baseband processing for the particular air interface that is being used to wirelessly communicate over one or more radio frequency channels. The radio unit, RU, performs radio frequency processing to convert baseband data output from the BBU to radio frequency signals for radiating from one or more antennas coupled to the RU and/or to produce baseband data for the BBU from radio frequency signals that are received at the RU via one or more antennas. The RU may be installed near the one or more antennas, (e.g., at the top of a tower), and the BBU may be installed in a more accessible location, (e.g., at the bottom of the tower). However, the RU and BBU may be collocated, e.g., in a lab. The BBU and the RU may be connected through one or more fiber optic links. The interface between the BBU and the RU is defined by fronthaul communication link standards such as the Common Public Radio Interface (CPRI) or Enhanced Common Public Radio Interface (eCPRI) family of specifications, the Open Base Station Architecture Initiative (OBSAI) family of specifications, and the Open Radio Interface (ORI) family of specifications.

The frequency domain fronthaul is a functional split where the IFFT/FFT (Inverse Fast Fourier Transform/Fast Fourier Transform) may be moved from the BBU to the RU. Frequency domain samples instead of time domain samples are sent over the fronthaul. The RU will have information through a communication channel about the resource allocation for different UEs. The new eCPRI interface specification “eCPRI Specification V1.0 (2017-08-22)” is already available.

For the deployment scenario where the radio unit, RU, (sometimes also denoted as Radio Remote Unit, RRU or Remote Radio Head, RRH, or (evolved) radio equipment, eRE) and the baseband unit, BBU, (sometimes also denoted as (evolved) radio equipment controller, (e) REC or Distributed Unit, DU) are separated, the signals received from one or more antennas have to be transported over the media that is connecting the RU with the BBU as normally the signal combination is done at the BBU. The interface that is used for the connection between the BBU and the RU may be referred to as the fronthaul. The signals over the fronthaul may be complex time domain samples such as specified in the legacy Common Public Radio Interface, CPRI, or nowadays eCPRI. Digitized waveforms may be transported over the fronthaul from the BBU to the one or more RU, and vice versa, via one or more radio aggregation units (RAU). As illustrated, the BBU may be connected to a core network, Core, and possibly to other BBUs (not shown) via one or more backhaul or cross-haul connections. The one or more radio data packets may thus be transmitted over the fronthaul, e.g., between a radio unit and a baseband unit. A test device may be coupled to the radio unit and/or the baseband unit via the fronthaul, as will be discussed later. Hence, the one or more radio packets may be transmitted from the test device to the RU or BBU, or vice versa.

The user equipment's, UE, signals are power limited and as the path loss varies with the distance to the UE a large dynamic range is encountered when those signals are represented digitally, it may be assumed that for the complex frequency sample a large number of bits will be required and in the case of MIMO (Multiple Input Multiple Output)/diversity layers the required fronthaul capacity will multiply with the number of antennas. Furthermore, it is desired to model such propagation of radio signals to test the functionality of the radio system and its components. As the capacity on the fronthaul is limited, it is desired to find methods that optimize and/or monitor the usage of the fronthaul.

High speed data services are a target for operators and a need for users, especially professionals. The quality of synchronization has a direct impact into the Quality of Service. In addition, for telecommunication system performance, the radio equipment needs good synchronization to achieve a suitable separation and avoid channel interference.

The open fronthaul interface linking ORAN-distributed unit (O-DU), corresponding to the baseband unit BBU, and ORAN radio unit (O-RU), includes 3 major planes to provide the reliable connection between a distributed unit and one or more radio unit. The S plane, known as synchronization plane, plays the role of synchronizing the distributed unit with radio unit with respect to time, phase, and/or frequency synchronization. Moreover, the Management plane (M plane) is responsible for supporting FCAPS (Fault, Configuration, Accounting, Performance, Security) to the O-RU. Furthermore, the Control plane (C plane) and User plane (U plane) cover the data configuration and feature parameters and the actual radio data desired to be sent by the users, e.g., during operation and/or test.

In the uplink direction, the O-RU receives the wireless signal over antenna elements. The wireless signals, e.g., in the form of RF symbols, also denoted as RF signals in general, then may pass through an analog beamforming block, not shown, and/or an analog to digital converter block, not shown, whereupon the generated data is ready to be converted from time to frequency domain by the Fast Fourier transform (FFT) block, not shown. Afterwards, basic filtering and digital beamforming are performed in order to extract the actual data that may be compressed as IQ data. The IQ data may then be provided in the form of one or more radio data packets to be transmitted over the fronthaul.

In order to test the functionality of the baseband unit and/or the radio unit a test device may be used that provides stimulus, e.g., in the form of one or more radio data packets, to the radio unit and/or the baseband unit. The test device 1 may additionally or alternatively store the data transmitted and/or received by the baseband unit and/or the radio unit. Thus, the test device may be used to test and/or to monitor and/or analyze the functioning of the baseband unit and/or the radio unit.

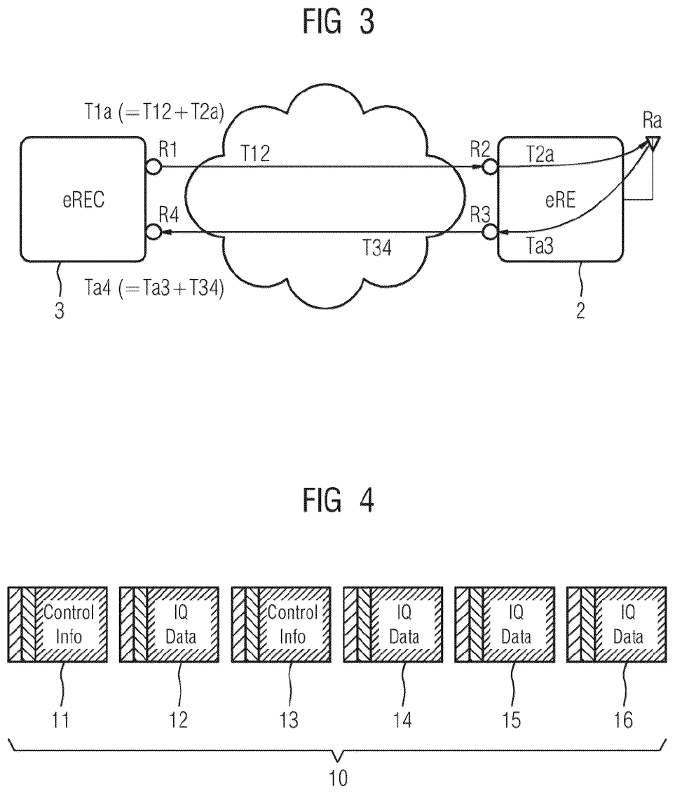

FIG. 2 shows an illustration of a test system including a test device, wherein the test device includes the functionality of the baseband unit, e.g., emulates the same. The test device itself may include the functionality of the baseband unit, e.g., to test the radio unit. To test the BBU and/or RU, the test device may transmit stimulus over the fronthaul (link) to the one or more devices under test. The stimulus may include IQ data to be processes by the device under test.

As the IQ data transmitted over fronthaul is in the frequency domain, the RF symbol duration directly affects the amount of time needed for radio data packet transmission. In other words, all bandwidth, amount of data compression, and eRE data rate may affect the transmission time. Furthermore, as the IQ data transmitted over the fronthaul, e.g., using eCPRI, is in the frequency domain, the RF symbol duration directly affect the amount of time needed for packet transmission. In other words, all bandwidth, amount of data compression, and radio unit data rate may affect the transmission time over the fronthaul.

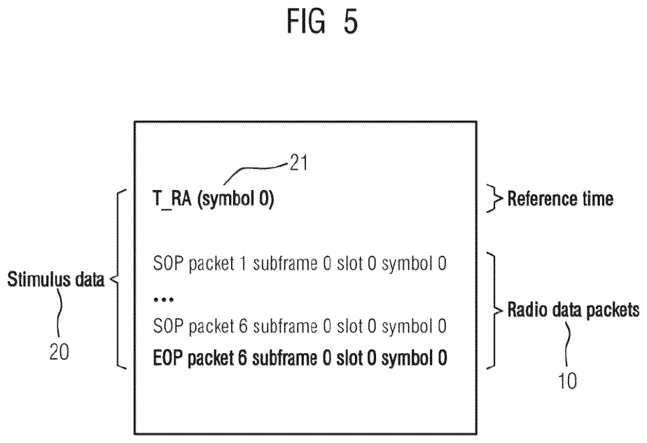

As shown in FIG. 3, e.g., in an eCPRI network, all nodes may be synchronized in different domains: frequency, time, and phase domain. In the downlink direction, the following timing parameters are present: T12 transport network delay between port 1 and port 2. T12 may vary in an interval named transport variation. It is bounded with T12min and T12max. T12min is the minimum delay of the fastest path data may take to link the two nodes. T12max is the maximum end to end one-way delay. Therefore, the User data will take a delay T12 such that: T12min<T12<T12max.

T1a is the timing difference between the transmission of a radio data packet at the output point R1 of the eREC and the transmission of IQ samples at the antenna Ra of the eRE. The transmission of the earliest IQ sample which is generated from the transmitted radio data (in the one or more radio data packets) is the RF symbol time Tsym at the antenna Ra.

T2a is the timing difference between the reception of a radio data packet at the input point R2 of eRE and the transmission of IQ samples at the antenna Ra (as one or more RF symbols). The transmission of the earliest IQ sample at the antenna is the RF symbol time Tsym. If a user data packet arrives outside of this reception window (i.e., earlier than T2a max or later than T2a min), the radio data packet may not be used and consequently IQ samples and thus RF symbols related to this radio data packet may not be generated correctly.

As the respect for packet timings and the required Time Advance values is of the biggest concerns in getting, e.g., O-RAN, based fronthaul networks to work reliably, sufficient timing accuracy is required.

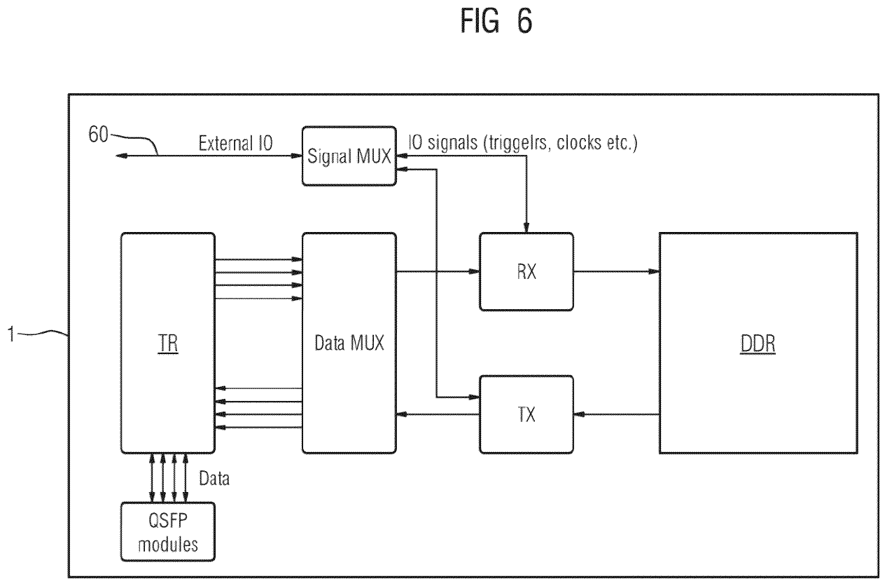

FIG. 4 shows an illustration of radio data packets 11-16. For example, the control plane data, also referred to as C plane, is sent separately from the user plane data, also referred to as U plane. For the downlink case, C plane radio data packets 11, 13 are sent before the U plane radio data packets 12, 14, 15, 16 with a specific period of time that allows the O-RU to process and be ready for the next received U plane radio data packet, coming from the same source BBU, e.g., an O-DU. This C plane data packet 11, 13 is sent again in the next slot. Depending on U plane characteristics and patterns, the C plane may be either the same copy or may be reconfigured. The C plane and the U plane radio data packets 11-16 may include data encapsulated using eCPRI or IEEE1914.3 mechanism. As shown in FIG. 4, the control information and the IQ data are preceded by IP and/or Ethernet header and a C plane header or a U Plane header, respectively, illustrated by the small boxes at the beginning of the data packets 11-16. The IQ data may be in the frequency domain. The control information radio data packets are sent before the U plane data packets. Every slot C plane data packet precedes U plane radio data packet by a certain period of time defined by time management parameters known as T cp_adv_dl. This amount of time allows O-RU to update beamforming weights linked to the user data in a DL direction. Similarly, the C plane packet, in UL data flow, is used to adapt the processing of the O-RU for the U plane data coming to its antenna.

The U plane radio data packets may be separated into two parts. The first defines the scheduling, beamforming commands information followed by the IQ data. The U plane data may exceed the maximum ORAN specified data packet size. In such cases, the data is split over multiple radio data packets. Data may be organized in many section types. Data that belongs to different sections may be sent separately. Whenever the IQ data are not achieving 1 byte alignment, stuffing bits are added at the end of a section.

Hence, when receiving an RF signal in the RU antenna (uplink direction), the radio unit will digitize data and wrap it up into the IQ data, e.g., according to (e) CPRI protocol. The radio data packets including the IQ data may then be transmitted through, e.g., an optical fiber, reaching the BBU, and possible a backhaul afterwards. Hence, an RF symbol may correspond to one or more IQ samples that are provided in one or more radio data packets and, e.g., transmitted via the fronthaul. In the downlink direction, the baseband unit sends user data to RU enveloped according to a fronthaul protocol, such as (e) CPRI protocol. The user data may also be in the form of IQ data and present in the one or more radio data packets, e.g., transmitted over the fronthaul. The (e) CPRI frames will be unpacked, converted to analog signals, and then transmitted over the air as RF symbols or RF signals in general. For example, a CPRI radio frame includes a 10 ms time period. Therein, 256 basic frames, each basic frame if of 260 ns, constructs one hyper frame of period 66.7 μs. A collection of 150 hyper frame takes a shape of 10 ms frame which is the radio frame.

As mentioned, transmission of one or more radio data packets via the fronthaul requires packetized Control- and User-plane data to be sent from O-DU to O-RU in advance, so that the radio unit may perform required data processing and digital-to-analog conversion well in time before the actual symbol time in the air interface, RF antenna. This amount of “advance” is configurable, e.g., per O-RU requirements and the verification of correct arrival time windows is of essence in providing correct operation of the fronthaul network and the interoperability between O-DU and O-RU. The problem in this verification is that the actual RF-side symbol time is not visible to the fronthaul, and without such symbol time reference, radio data packet arrival time windows cannot be reliably established, and it is impossible to say if packets arrived too early (exceeding the buffering capabilities in radio unit) or too late (radio unit does not have enough time to prepare the symbol data for RF transmission).

Furthermore, the lack of such an RF time reference in a radio test system (modeled or real SoC) complicates data analysis in the RF interface side, in the ADC/DAC interface of a radio unit. Hence, RF symbols time-wise locations are not known and cannot be reliably verified by the IQ data analysis.

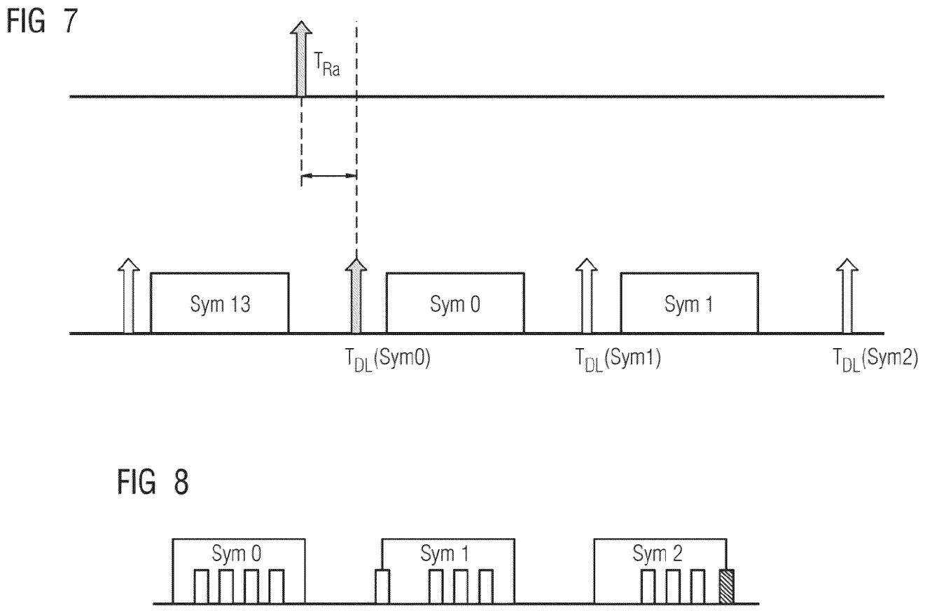

It is thus proposed to include a reference time as part of the stimulus to be transmitted to the fronthaul link. The stimulus data is illustrated in FIG. 5. The reference time may mark a RF symbol time, i.e., the point in time the RF symbol transmission of one or more radio data packets starts. Thereby, the RF symbol/frame reference is known and/or is synchronized with the radio data packets of the stimulus data. A reference signal, e.g., in the form of a pulse, representing the reference time may be forked out from the stimulus data to its own signal path, e.g., before fronthaul transmission. The signal path for the reference signal may be a separate cable, e.g., in HW-based environment, or a dedicated RF frame pulse signal, e.g., in a model-based environment.

Similarly, together with radio data packet captures from the fronthaul, a reference signal may be recorded as part of the data capture. Thereby, it is possible to combine the timings of both digital fronthaul domain and the analog RF domain.

Having the exact time of an RF-side reference pulse, (e.g., a 1 PPS signal in an RF test environment), recorded as part of the data packet capture, a detailed symbol time analysis may be performed, e.g., by inter- and/or extrapolation, to establish one or more acceptable arrival time windows for each RF symbol separately. Taking the required C- and U-plane advance values into account, it is possible to determine if the radio data packets carrying physical resource blocks (PRB) parts of a symbol, falls within the acceptable time window, or outside of it. By linking ADC/DAC data to RF frames, it is possible to determine how the PRBs are translated into time-domain data, i.e., whether the RF symbol times at the RF side are within the acceptable time window.

It is thus proposed to generate a reference time, in particular a reference pulse, and to include this reference time in the stimulus data, e.g., for a device under test, such as a radio equipment, e.g., a radio unit. The reference time may thus be part of the stimulus data. This stimulus data, i.e., the radio data packets and/or the reference time(s), may be generated according to a radio modeling environment, e.g., modelling one or more radio channels. As mentioned, it is possible to record the reference time, e.g., by recoding a reference pulse, as part of (timestamped) radio data packet capture. PCAP, for instance, is heavily used as Ethernet-based packet capture format, but it does not support transmission or reception of such auxiliary information. A formatting of the stimulus, e.g., including radio data packets, is proposed, that allows the definition, injection, timestamping, and/or capture of external events, in particular a reference time. These external events, such as the reference time or a corresponding reference signal, may not be Ethernet or O-RAN data packets and may not occur in the fronthaul, e.g., may not be transmitted over a high-speed serial data link.

The reference time may serve to determine a RF frame or RF symbol boundary. Based on this expected RF frame or RF symbol boundary the timing accuracy of the device under test may be determined. To that end, the actual RF frame or RF symbol boundary may be determined and compared expected RF frame or RF symbol boundary (determined based on the reference time). The ability to generate a reference signal for a RF frame boundary may be necessary for a test system (simulated, emulated, and post-Silicon) where there is no possibility to obtain such reference time from global navigation satellite system and/or where O-RAN Sync Plane facilities (PTPv2) do not exist yet. Generating such a RF symbol/frame reference time into this timing-wise isolated test system enables a synchronization across the entire test system, e.g., from stimulus source in fronthaul to data sink in the ADC/DAC interface of the radio unit, and vice versa. Having the reference time as part of stimulus data makes it possible to align (or intentionally misalign) radio data packet timings with the RF symbol/frame time. Optionally, the reference time or other external event may be visualized together with the radio data packets and/or stimulus data. This allows further analysis of radio data packet timings over the fronthaul and/or the device under test, in particular RF symbols processing in the ADC/DACs, e.g., of the analog and/or digital RF interface of the radio unit. With the timestamp of the RF-side symbol/frame pulse, it is possible to inter- and extrapolate the RF symbol boundaries from the reference time (or corresponding reference pulse) by calculating the RF symbol duration, e.g., for each antenna-carrier separately, based on the subcarrier spacing and/or cyclic prefix length. Having a timing reference pointing at a RF symbol or RF frame boundary in the RF interface, it is possible to reliably interpolate RF symbol locations, in particular one or more symbol boundaries, from the reference time, e.g., corresponding reference pulse, for example, in order to inspect time-division duplex (TDD) switching patterns and contents of each RF symbol.

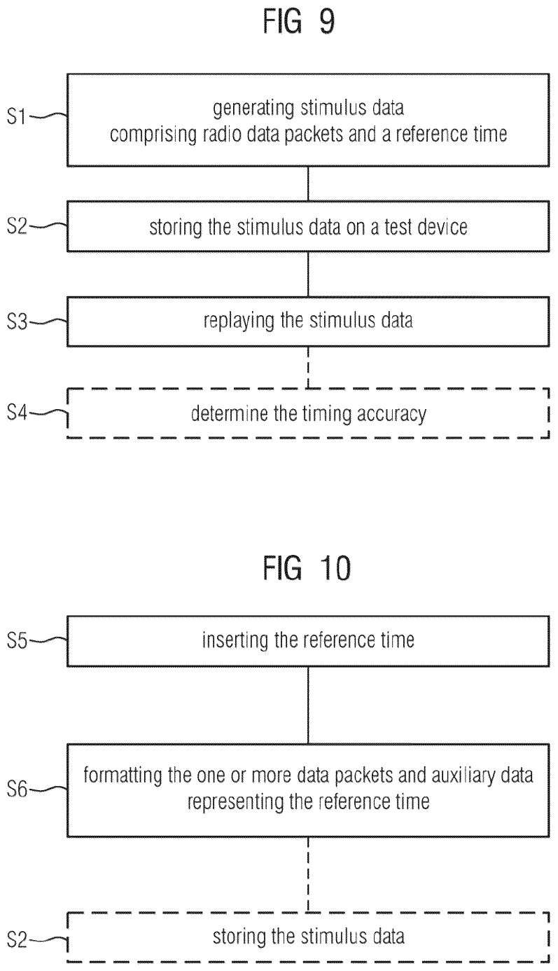

Turning to FIG. 6, the reference time may be stored as part of a file, e.g., in an (adapted) PCAP format. For example, the reference time may be stored in a format, such as PCAP, as a separate file or a separate packet in a PCAP file, e.g., in a memory of the test device, for example DDR in FIG. 6. Therein the reference time may be marked as TRa, i.e., an external event. Hence when processing the stimulus data, the reference time is forked out before the radio data packets are transmitted over the fronthaul. The reference time may be a 1 PPS or 10 ms frame pulse signal, which is inserted into the radio data packet-based stimulus data. The reference time may as well be recorded, e.g., by recording a reference pulse, as part of a fronthaul packet capture. This allows calculating and thus analyzing the radio data packets and corresponding arrival time windows, e.g., at one or both ends of the test system, e.g., at the BBU or RU, for example by capturing the radio data packets and a reference pulse by a test device.

The test device may include, as shown in FIG. 6, a transceiver TR which is connected to a (independent) receiver module RX and/or transmitter module TX, e.g., forming a datapath to and/or from the memory, e.g., DDR, respectively. The transmitter and/or receiver RX, TX may be included in the transceiver TR, e.g., as well as the Data Mux module. The Data Mux module may provide bit-level multiplexing in both the TX and RX directions. The Data Mux function is for example described in clause 83.5.2 of IEEE Std 802.3ba-2010.

For example, in the uplink, a test device may capture inbound fronthaul protocol frames, i.e., radio data packets including IQ data, into its memory, such as a DDR4 memory. Along with the high-speed serial data capture, e.g., from a fiber-optic link for example through SFP or QSPF interfaces, as shown in FIG. 6, the test device 1 is also able to record one or more auxiliary timing pulses, such as the reference signal as part of that captured data. The test device may receive the reference signal via a separate data path. The one or more reference signals may be in sync with the inbound data, so that the reference signal, e.g., in the form of a reference pulse, may be used to record a reference time and thereby mark events of time for analyzing the captured radio data packets. The reference time may be saved, for example, as part of the 8b10b coded XGMII data structure, e.g., in its spare bits, for example, when the reference signal is detected. The spare bits result from the fact that the 8+K information that needs to be stored to be able to recover the original 10b conversion words of the 8b10b code, leaves one spare bit when incoming code words are saved in groups of 4 bits to occupy a 40-bit area in a memory, e.g., RAM, of the test device. The 40-bits are a handy number from a memory and/or software point of view, because data may be read one byte (8 bits) at a time. Thus, 5 bytes correspond to an even number of 40 bits and requires no additional operations, such as shifting operations. Thus, in total this leaves 4 spare bits per 4 protocol data words. These one or more spare bits may be used for recording a reference signal, e.g., representing the reference time, or another external event.

A software application, such as a software module described herein, e.g., for protocol generation and analysis, may transmit data, e.g., the one or more radio data packets, through the transceiver TR by writing data (from the memory, e.g., DDR), to the TX module. Similarly, a software application may receive data, i.e., in the form of one or more radio data packets, through the transceiver TR by receiving data from the RX module. As shown in FIG. 6, a reference pulse may be received and/or transmitted by a signal multiplexer module, Signal Mux, that is connected to the RX and/or TX module. As explained a reference pulse may be saved as part of the line coding, e.g., 8b10b, data structure. Similarly, a reference pulse is generated when auxiliary data (representing a reference time) is present in the stimulus data to be transmitted.

A software module such as a protocol generator and/or analyzer may be configured to recognize the reference signal, e.g., based on the spare bit locations in the XGMII data. For example, a reference pulse in location spare0 is (automatically) recognized as a RF frame or 1 pulse per second (PPS) boundary in the air interface, i.e., a reference time T_Ra. This reference time may be used to relate the RF time to fronthaul time and perform fronthaul time window calculations.

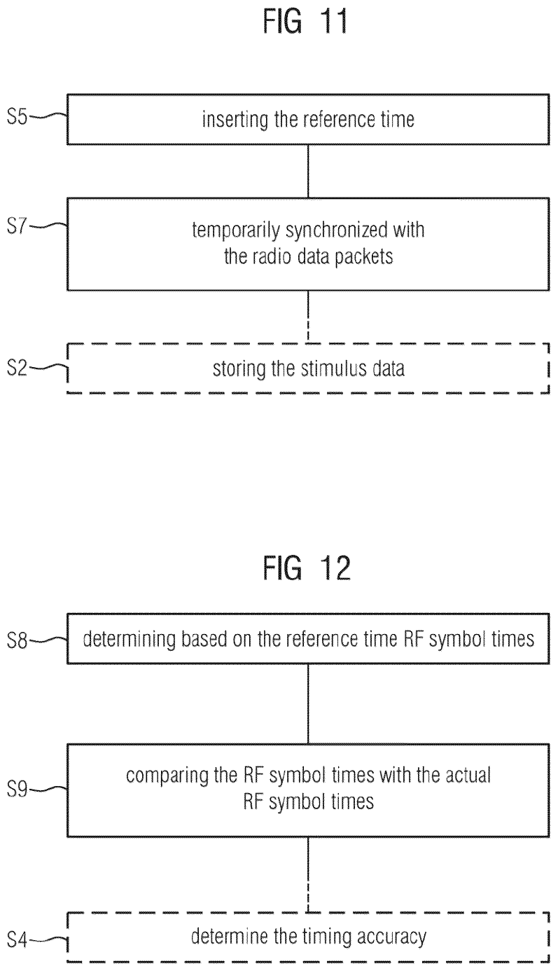

A software module, such as the protocol generator and/or analyzer may (pre-) generate protocol RF frames into a memory, such as a DDR4 memory, of the test device as stimulus data to be transmitted to the device under test (DUT). It is to be understood that the protocol is an internal protocol that is used for radio data packets to be generated, stored and/or transmitted within the test device. As part of this protocol RF frame generation, as shown in FIG. 7, it is possible to insert general-purpose I/O signals (pulses), e.g., in the form of auxiliary data, in the protocol data. The reference signals are time-synchronous with the protocol data and may be used to denote events of time and/or may serve as triggers for external equipment, such as DUT and especially a radio unit or baseband unit. Specifically, for fronthaul protocols, such as O-RAN, and the need to signal a reference time, e.g., to a radio frequency (RF) analyzer in the antenna side of the DUT, e.g., a radio unit, this reference signal may take the form of a pulse and may be generated, e.g. based on the auxiliary data, to coincide with the pre-calculated RF (sub) frame, RF slot and/or RF symbol boundary T_Ra=0. The reference pulse, as shown in FIG. 7, will for example be emitted (by the test device) when stimulus is transmitting at time required advance time, T=<required advance>. That is, the required amount of radio data packets for a certain RF symbol or RF frame have already departed test device before the reference pulse, i.e. the T_Ra frame boundary pulse, is emitted, because of the advance requirement of the fronthaul and/or the device under test.

The auxiliary data is extracted from stimulus data, or more specifically, extracted from the (internal) protocol data, for example in a protocol processing module such as transmitter module TX. Based on the auxiliary data a reference pulse may be generated, for example by signal multiplexer, Signal Mux. A signal multiplexer may then route the reference pulse 60, e.g., to an (external) connector (of the test device). For example, SMA, SubMiniature version A, connector may be used as a connector. The radio data packets from the stimulus data passes through the data multiplexer that controls the fronthaul transmission, e.g., via the SFP or QSFP port assignments. The fronthaul transmission of the radio data packets of the radio data packets from the stimulus data may occur via an SFP or a QSFP fiber-optic module for high-speed serial transmission. The latencies of these two parallel transmission paths, i.e. for the radio data packets and the reference signal, are balanced, so that the reference pulse arrives at its destination, e.g., a DUT, such as a radio unit and/or other RF equipment, at the same time as its corresponding radio data packet-provided that the connection distance between the test device and the device under test is short so that the fronthaul latency becomes negligible. The proposed method, apparatus, and system, to generate RF frame reference pulse for example is applicable for early system-on-chip (SoC) testing where more complex and cumbersome mechanisms may be unavailable.

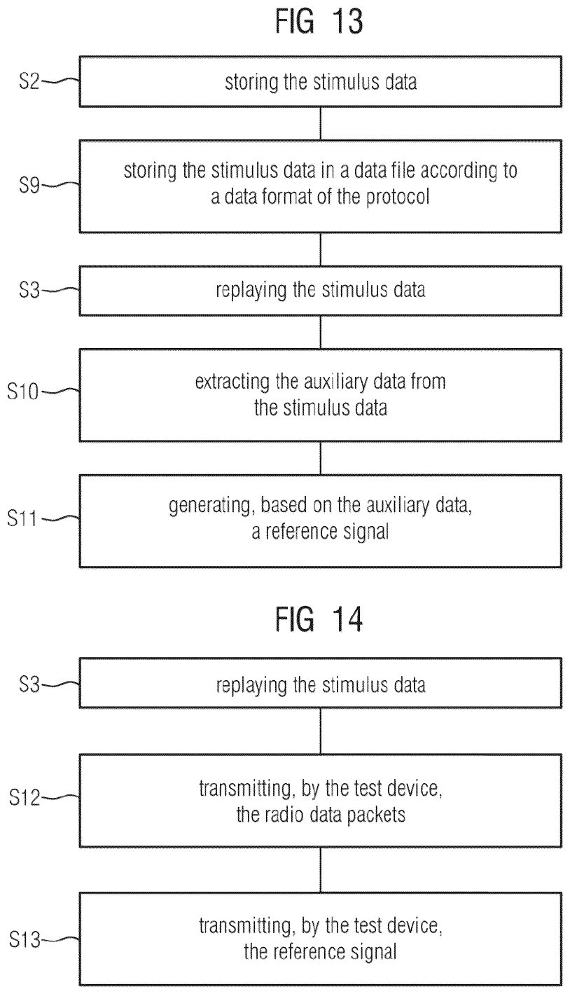

Turning to FIG. 8, by recording, e.g., saving, the reference time TRa, the past and future RF symbol boundaries, i.e. Tsym, may be interpolated and/or extrapolated. Furthermore, the specific Time Advance values (for the Control and/or User plane) may be taken into account, which enables determining time windows for the radio data packet transmission at the baseband unit, e.g. O-DU, or reception, e.g., at the radio unit, for example, at the O-RU, depending on which end of the fronthaul (link) the radio data packet has been captured, i.e., whether the (O-RAN) Fronthaul latency (namely T12) may need to be taken into account or not.

In this way, correctly timed radio data packets are located inside the acceptable time window and too early or too late data packets fall out of the time window. Thereby, timing violations become evident. In addition, the positioning of the radio data packets may be visualized, and a user is able to determine whether the radio data packets are received at the beginning, center, or end of the time window. By the radio data packets captured, a user may see if delays are due to high link utilization or whether another problem exists. In FIG. 8, acceptable (transmission) time windows for RF symbols (symbol 0 . . . 13) are shown and overlayed with the radio data packets for the respective RF symbol. Thereby, a delay of radio data packet transmission becomes evident. As explained earlier, the time windows may be generated based on the reference time TRa in the stimulus data.

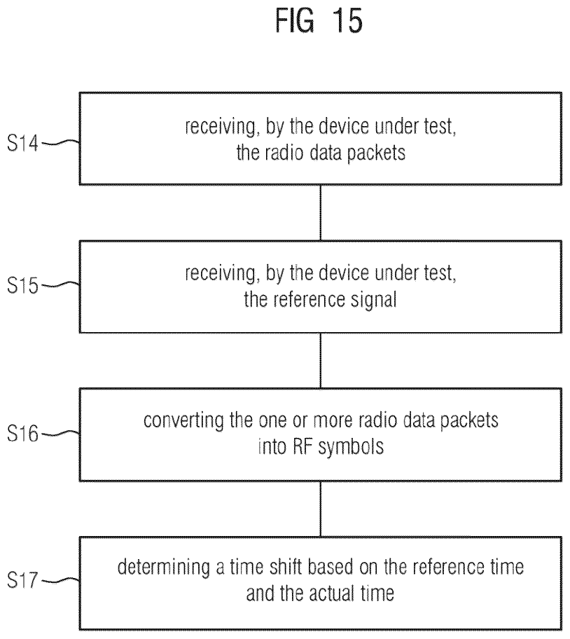

FIG. 9 shows exemplary acts according to a first embodiment. In act S1, stimulus data including radio data packets and a reference time is generated, for example, using a software module for protocol generation and/or analyzation. The software module may (pre-) generate protocol RF symbols and/or RF frames into a memory, such as a DDR4 memory, of the test device as stimulus data to be transmitted to the device under test (DUT). To that end, the RF frames may be represented by one or more radio data packets. The radio data packets may include IQ data representing the RF symbols and/or RF frames. The stimulus data may also include a reference time for transmission of the radio data packets (10) over the air.

In act S2, the stimulus data on a test device is stored on a test device. For example, the software module for protocol generation and/or analyzation may access a memory on the test device. The software module may be executed using a processor of the test device or may be executed on a separate device and access the memory of the test device for storing the stimulus data generated.

In act S3, the stimulus data is replayed by the test device. To that end, the radio data packets of the stimulus data may be transmitted over a fronthaul (network) and the reference time may be forked out and transmitted to a device under test via a separate link. To that end, a software module, e.g., above mentioned software module for protocol generation and/or analyzation, may be used that accesses the memory. The stimulus data may be replayed once or repeatedly, i.e., for a number of iterations.

In act S4, the timing accuracy may be determined.

The reference time may be used to compare the actual RF symbol time at the antenna to the reference time and thereby determine a timing accuracy of the radio data packets over the fronthaul and/or the device under test, e.g., a radio unit.

In FIG. 10, further method acts are shown n FIG. 10. In act S5, the refence time may be inserted in between the radio data packets. Thus, the act of generating stimulus data may further include (inserting the reference time by) formatting, in act S6, the one or more radio data packets and auxiliary data representing the reference time according to a data format of a protocol. For example, the radio data packets may be generated first and the reference time inserted afterwards. In act S2, the stimulus data may then be stored as described herein.

In FIG. 11, further acts are shown. In act S5, as in the above, the reference time is inserted in the stimulus data. In act S7, the auxiliary data representing the reference time is inserted temporarily synchronized with the radio data packets, e.g., temporarily synchronized with the IQ data of the one or more radio data packets. Thus, in act S2, the stimulus data is stored, e.g., in a memory of the test device, for example to be replayed as described herein.

In FIG. 12, further method acts are shown. In act S8, one or more RF symbol times for the one or more radio data packets of the stimulus data may be determined based on the reference time T_Ra. For example, based on the reference time stored in the stimulus data (as represented by auxiliary data therein) a RF symbol time may be calculated. The RF symbol time may be calculated (and thus corrected) based on alpha and beta parameters of the fronthaul. Furthermore, one or more RF symbol may be extrapolated or interpolated based on the reference time. In act S9, the RF symbol times determined (according to act S8) may be compared to the actual RF symbol times (at the air interface or antenna of the DUT). Thus, based on the comparison of the RF symbol times (according to act S9) the timing accuracy of the radio data packets may be determined in act S4.

In FIG. 13, further method acts are shown. In act S2, as before, the stimulus data may be stored. The act of storing may include storing, in act S9, the stimulus data in a data file according to a data format of a protocol. The format may be chosen as to provide (in addition to the radio data packets and/or the IQ data) a data entry for the reference time, e.g., in the form of the auxiliary data (representing the reference time). In act S3, the stimulus data in the format of the protocol may first be stored, e.g., in a memory of the test device. The format hence already includes the radio data packets. The radio data packets may be (pre-) generated by a software module for generating and storing stimulus data. The stimulus data in the form of the one or more radio data packets is ready to be transmitted from the memory as is. Alternatively, IQ data may be stored and packetized into the radio data packets. In that case, the radio data packets are (only) created from the IQ data when they are (to be) transmitted over the fronthaul.

In act S10, the auxiliary data is extracted from the stimulus data, e.g., before transmission of the one or more radio data packets also included in the stimulus data. In act S11, a reference signal is generated based on the auxiliary data. As described, the auxiliary data is used to generate the reference signal using, e.g., a data and/or signal multiplexer. The reference signal 60 may then be transmitted by the test device, e.g., to the device under test.

In FIG. 14, further acts are shown. In act S3, the stimulus data may be replayed. Act S3 may include or may be followed by act S12 and or S13. In act S12, the radio data packets are transmitted by the test device. In act S13, the reference signal is transmitted by the test device, e.g., both times to the device under test.

In act S14, as shown in FIG. 15, the radio data packets are received by the device under test, as well as the refence signal, in act S15. One or more RF symbols are created in act S16 based on the IQ data in the radio data packets received by the DUT. The RF symbol time of the device under test may then be compared to the symbol time as determined based on the reference signal (representing the reference time). Thus, in act S17, a time shift, i.e., a time difference, between the reference time and the actual time the RF symbol is present at the air interface or antenna may be determined in order to determine the timing accuracy of the radio data packets transmission and processing, e.g., by the DUT.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for determining timing accuracy of one or more radio data packets, the method comprising:
generating stimulus data, wherein the stimulus data comprises the one or more radio data packets and a reference time for transmission of the one or more radio data packets over-the-air;
storing the stimulus data on a test device; and
replaying the stimulus data, by the test device, in order to determine the timing accuracy of the transmission of the one or more radio data packets by a device under test.

2. The method of claim 1, wherein the generating of the stimulus data of comprises inserting the reference time by formatting the one or more radio data packets and auxiliary data representing the reference time according to a data format of a protocol.

3. The method of claim 2, wherein the inserting of the auxiliary data representing the reference time is temporarily synchronized with the one or more radio data packets.

4. The method of claim 3, wherein the reference time indicates a point in time at which one radio data packet of the one or more radio data packets is or should be present at an antenna interface of the device under test.

5. The method of claim 4, wherein the reference time indicates a radio frequency (RF) frame and/or a RF symbol boundary for transmission of at least one radio data packet of the one or more radio data packets via the antenna interface of the device under test.

6. The method of claim 5, further comprising:
determining, based on the reference time, over-the-air radio symbol times or RF symbol boundaries for the one or more radio data packets.

7. The method of claim 1, wherein the stimulus data is stored in a data file according to a data format of a protocol.

8. The method of claim 2, wherein the replaying further comprises:
extracting the auxiliary data from the stimulus data; and
generating, based on the auxiliary data, a reference signal for transmission from the test device to the device under test.

9. The method of claim 1, further comprising:
transmitting, by the test device, the one or more radio data packets to the device under test,
wherein the one or more radio data packets are transmitted via a first communication link or fronthaul link, and
wherein a reference signal is transmitted a via second communication link.

10. The method of claim 1, further comprising:
receiving, by the device under test, the one or more radio data packets from the test device,
wherein the one or more radio data packets are received via a first communication link or fronthaul link, and
wherein a reference signal is received via a second communication link.

11. The method of claim 1, further comprising:
converting, by the device under test, the one or more radio data packets into radio frequency (RF) symbols for transmission over-the-air via an antenna.

12. The method of claim 1, further comprising:
determining a time shift based on the reference time and an actual time the one or more radio data packets are present at an antenna or interface.

13. A test device comprising:
a processor and a memory configured to:
generate stimulus data, wherein the stimulus data comprises one or more radio data packets and a reference time for transmission of the one or more radio data packets over-the-air;
store the stimulus data on the test device; and
replay the stimulus data in order to determine a timing accuracy of the transmission of the one or more radio data packets by a device under test.

14. (canceled)

15. A system comprising:
a device under test; and
a test device, wherein the test device is configured to:
generate stimulus data, wherein the stimulus data comprises one or more radio data packets and a reference time for transmission of the one or more radio data packets over-the-air;
store the stimulus data on the test device; and
replay the stimulus data in order to determine timing accuracy of the transmission of the one or more radio data packets by the device under test.

16. (canceled)

17. The method of claim 3, wherein the inserting of the auxiliary data representing the reference time is temporarily synchronized with IQ data of the one or more radio data packets.

18. The method of claim 6, wherein the determining is based on a subcarrier spacing and a cyclic prefix.
